(19) United States
(12) Patent Application Publication
(10) Pub. No.: US 2014/0272882 A1
(43) Pub. Date: Sep. 18, 2014

(54) DETECTING ABERRANT BEHAVIOR IN AN EXAM-TAKING ENVIRONMENT

(71) Applicant: Kryterion, Inc., Phoenix, AZ (US)

(72) Inventors: James Kaufman, Phoenix, AZ (US); Andrew Caldwell, Phoenix, AZ (US)

(73) Assignee: Kryterion, Inc., Phoenix, AZ (US)

(21) Appl. No.: 14/207,637

(22) Filed: Mar. 13, 2014

Related U.S. Application Data
(60) Provisional application No. 61/780,597, filed on Mar. 13, 2013.

(51) Int. Cl. G09B 5/06

(52) U.S. Cl. CPC G09B 5/065
USPC 434/308

(57) ABSTRACT

Systems and methods for detecting aberrant behavior in a testing environment involve receiving real-time audio-visual data from a detection device and executing an application stored in memory that, when executed by a processor, detect aberrant data within the real-time audio-visual data and reacting automatically to the aberrant data.

### CROSS-REFERENCE TO RELATED APPLICATION

This application claims the priority benefit of U.S. provisional application No. 61/780,597 filed on Mar. 13, 2013 and titled “Detecting Aberrant Behavior in an Exam-Taking Environment,” the disclosure of which is incorporated herein by reference.

### BACKGROUND

1. Field of the Disclosure

The present disclosure generally concerns proctored examinations. More specifically, the present disclosure concerns detecting aberrant behavior in an exam-taking environment.

2. Description of the Related Art

Examinations are used to determine the ability of an exam taker such as a student or prospective practitioner as it pertains to proficiency in a particular subject or skill set. For example, a student might take an exam to determine whether the student possesses requisite knowledge in a particular subject that might be related to receiving a degree or certificate. A prospective practitioner in law or medicine might similarly sit for examination to determine their competence as it pertains practicing in that profession.

Students or prospective practitioners have historically gathered at the designated locale for an examination on a proscribed date and time. Testing materials are then handed out by a testing authority and the exam begins. During the allotted exam time, the exam takers read questions and provide answers on a provided answer sheet or in a blue book. Throughout the course of the examination, a teacher or a proctor keeps careful watch over the exam takers to ensure that no instances of cheating are taking place. While a single proctor may be able to observe a small group of exam takers, such observation becomes more difficult for a larger exam-taking pool or for a group of exam takers utilizing laptop computers or other computing devices.

The increased popularity of distance learning has also complicated proctoring of examinations. The distance learning instructional model delivers education material and information to students who are not physically on-site at an educational facility. Distance learning provides access to learning opportunities when the source of the information and the student are separated by time or distance if not both. Thousands of distance learners may be involved in a particular distance learning program or course at any given time.

Distance learning is no different than any other educational program in that there is a need to verify the qualifications of students through testing and examination. Because distance learners are not collectively gathered at a physical learning institution such as a university, the distance learning program often either requires that the students attend a testing center—which defeats one of the primary purposes of distance learning—or it administers an examination online. An online examination is difficult to proctor as an exam taker could be taking an examination in one window of a web browser while looking up answers in another window via the Internet. An exam taker could also utilize a chat or messaging application to relay questions to and receive answers from a knowledgeable third-party. The value of online examinations is therefore questionable and calls into question the overall value of the corresponding class or degree program.

There is a need in the art for improved proctoring of large scale examinations such that a few of proctors can properly secure an exam-taking environment notwithstanding having to monitor large quantities of exam takers. Accordingly, there is also a need for improved an improved system for detecting aberrant behavior in exam-taking environments.

### SUMMARY OF THE CLAIMED INVENTION

A system for detecting aberrant behavior in a testing environment may include a detection device that receives real-time audio-visual data and a computing device communicably coupled to the detection device. The computing device may have a testing application stored in memory that includes an executable assessment module. When executed by a processor, the assessment module may detect aberrant data within the real-time audio-visual data and reacts automatically to the aberrant data.

A method for detecting aberrant behavior in a testing environment may include receiving real-time audio-visual data from a detection device and executing an application stored in memory. Execution of the application by a processor may cause the processor to detect aberrant data within the real-time audio-visual data and reacts automatically to the aberrant data.

A non-transitory computer-readable storage medium may have an executable program embodied thereon. Execution of the program by a processor may perform a method for detecting aberrant behavior in a testing environment, which may include receiving real-time audio-visual data from a detection device, detecting aberrant data within the real-time audio-visual data, and reacting automatically to the aberrant data.

### BRIEF DESCRIPTION OF THE DRAWINGS

FIG. 1 illustrates an exemplary exam-taking system for an online proctored examination.

FIG. 2 illustrates an exemplary assessment module before the assessment module has detected aberrant data.

FIG. 3 illustrates the exemplary assessment module of FIG. 2 after the assessment module has detected aberrant data.

FIG. 4 illustrates an exemplary method for implementing an online proctored examination.

FIG. 5 illustrates an exemplary branded interface for establishing an exam taker account.

FIG. 6 illustrates an exemplary interface for scheduling an online proctored examination.

FIG. 7 illustrates an exemplary method related to capturing biometric information utilized in an online proctored examination

FIG. 8 illustrates an exemplary interface for capturing biometric information related to keystroke analytics.

FIG. 9 illustrates an exemplary interface for capturing biometric information related to visual recognition of an exam taker.

FIG. 10 illustrates a first exemplary interface utilized in proctoring an online examination.

FIG. 11 illustrates a second exemplary interface utilized in proctoring an online examination that may be launched in response to detecting aberrant behavior observed in the interface of FIG. 8.

### DETAILED DESCRIPTION

A system for detecting aberrant behavior in an exam-taking environment is disclosed herein. Embodiments of the present invention allow for improved proctoring of secure, web-based, examinations through the use of a detection device and, among other things, object-recognition software. The use of detection devices such as webcams and microphones in conjunction with software designed to automatically recognize and react to the presence of certain real-time audio-visual data (e.g., the image of a particular animate or inanimate object in the exam-taking environment) greatly facilitates the ability of a single proctor to monitor a disproportionately large number of exam takers.

FIG. 1 illustrates an exam-taking system 100. System 100 may include a computing device 110 for taking an examination, a testing server 120 for administering the examination, a proctoring center 130, and a communications network 140. The examination may be a traditional question and answer format examination, or it may be a performance-based exam as described in U.S. patent application Ser. No. 12/913,697 entitled “Proctored Performance Analysis,” the disclosure of which is incorporated herein by reference. Persons of ordinary skill in the art will readily recognize that the present invention will work with any other type of examination as well. Communications network 140 may allow for the online exchange of testing data between computing device 110 and testing server 120. Communications network 140 may also allow for the observation of testing data and exam taker behavior by proctoring center 130. Computing device 110 may be secured for taking an examination as described in U.S. patent application Ser. No. 12/571,666, entitled “Maintaining a Secure Computing Device in an exam-taking Device,” and U.S. patent application Ser. No. 12/723,663 entitled “System for the Administration of a Secure, Online, Proctored Examination,” the disclosures of which are incorporated herein by reference.

Computing device 110 may be any computing device known in the art, such as a desktop computer, laptop computer, netbook, tablet, or smartphone. Computing device 110 may belong to a particular exam taker, or it may be a dedicated exam-taking computer as one might find in a testing center. Computing device 110 may include memory for storing data and software applications, a processor for accessing data and executing applications, and input and output devices for allowing an exam taker to interact with computing device 110. Computing device 110 may further include components that facilitate communication over communications network 140, such as an RJ-45 connection for use in twisted pair-based 10baseT networks or a wireless network interface card for connecting to a radio-based communication network (e.g., an 802.11 wireless network).

In addition to software applications, computing device 110 may include any number of files or other types of data such as notes, outlines, or exam preparation materials. Possession of this data—as well as having access to certain applications that themselves allow for access to data (e.g., a web browser)—during the course of an exam or examination would prove highly advantageous to an exam taker, but detrimental to the accuracy or relevance of the exam results. Similar issues would exist with respect to an exam-center computer that has access to the Internet or that might allow for the introduction of data through a portable storage device.

Testing server 120 may be a computing device tasked with the delivery of testing data, including questions, and other related application packages to the computing device 110 by means of communications network 140. Like computing device 110, testing server 120 may include memory, a processor for accessing data and executing applications, and components to facilitate communication over communications network 140.

Proctoring center 130 may be an operations center staffed by one or more persons observing various testing behaviors for one or more testing sites, which may be physically remote from proctoring center 130. Testing sites may include testing centers dedicated to administering examinations, traditional classroom settings, or even home or offices. Proctoring center 130 may observe and analyze a variety of different types of information to help ensure the integrity and security of an exam and/or testing environment. The observation and analysis of information is described in further detail below with respect to assessment module 170 and detection device 180. System 100 may also an onsite proctor (not shown) in place of, or in addition to, proctoring center 130.

Communication network 140 may be a local area network (LAN), which may optionally be communicably coupled to a wide area network (WAN) such as the Internet. Communications network 140 allows for communication between the various components of system 100.

Computing device 100 may be secured to prevent an exam taker from accessing applications, files, or data (e.g., notes, outlines, or exam preparation materials) during an examination. Computing device 110 may be secured through the download and subsequent installation of secure testing application 150. Secure testing application 150 may be downloaded from testing server 120 or another computing device coupled to communications network 140, such as testing registration server 160. Secure testing application 150 may also be installed from a computer-readable storage device such as a CD-ROM. Persons of ordinary skill in the art will readily recognize that there are numerous mediums through which testing application 150 may be delivered to computing device 100 for installation purposes. Testing application 150 may then be stored in memory on computing device 110 and executed by a processor as needed. When executed, testing application 150 may prevent computing device 110 from accessing certain data or applications that might otherwise be in violation of testing regulations or protocols as identified by testing server 120.

Testing application 150 may cause the computing device 110 to operate in a secure mode by introducing certain changes to the system registry such that only those applications or files deemed necessary or appropriate by the exam administrator and as embodied in a corresponding testing protocol may be allocated address space, loaded into memory, and ultimately executed by the computing device 110. For example, a testing protocol for a particular examination may deny access to a web browser, e-mail client, or chat application to prevent an exam taker from electronically communicating with other individuals during the examination. This particular protocol may be downloaded to the client computing device 110 from the testing server 120 along with testing data. The secure testing application 150 then operates in accordance with the downloaded testing protocol such that the aforementioned applications are not allowed to be loaded and executed. Because the applications that may be installed on a computing device are all but infinite, the testing protocol may identify those applications that an exam taker is allowed to access rather than those applications to which access is prohibited.

Similar prohibitions or permissions may apply to hardware components of the computing device 110, as well as any number of hardware peripherals that might be introduced to the computing device 110. Such hardware peripherals may include, among many other devices, a second computer monitor, a docking station, a traditional full-sized keyboard, or a USB flash drive. The protocol may also concern hardware at the computing device 110 that involves network connectivity. Network connectivity may be allowed prior to commencing an examination such that certain data may be downloaded. This data may include the actual exam (e.g., prompts and questions) or other data concerning an exam. Once the certain data is downloaded, however, network connectivity may be deactivated by locking out a network card until the exam is completed and the network card is released. Once the exam is complete, the network card may be re-enabled to allow for transmission of data or to allow for the free and general exchange of data rather than a more limited set under the control of testing application 150.

In some instances, network connectivity may be maintained throughout the course of the examination. This may be relevant to a scenario where testing data is maintained at testing server 120 and only displayed at computing device 110. In such an instance, the exam data itself may never be stored or downloaded at the computing device. It may be necessary to allow certain data to be exchanged over the network connection during the course of the examination. This may include both incoming data (e.g., questions) and outgoing data (e.g., answers).

In those instances where testing application 150 allows access to certain applications on computing device 110, the functionalities of those applications may be limited. For example, a testing protocol may allow for activation of a web browser and network connectivity, but only to a single secure site providing testing data. The protocol may further or alternatively allow for exchanges of only certain types of data or data that has been certified for exchange. Such certifications may include the presence of certain headers in the data or the data having been encrypted in a particular fashion. Similarly, the print function of a particular application may be disabled. The testing protocol may include instructions on how certain application programming interfaces (APIs) for certain commercially available software applications are to be implemented or disabled by testing application 150. Drivers may be managed in a similar fashion (e.g., a printer driver).

The occurrence of certain milestones or events during a testing event may correspond to the enablement or disabling of hardware, software, or specific application functionality. For example, print functionality may be disabled during an examination to prevent an exam taker from printing a copy of the examination and then delivering the copy to a friend so that they may review the questions before they take the examination. That functionality may be enabled, however, to allow the exam taker to keep a copy of their answers sans the questions. The functionality may be re-enabled once an exam taker clicks on a <Exam Complete> button or icon that locks in the exam taker's answers and prevents them from being further manipulated once certain hardware, software, or functionality of computing device 100 has been re-enabled that was otherwise disabled during the examination.

Because APIs vary in each application—and even between versions of the same application—testing application 150 (per the testing protocol) may only allow for the exam taker of certain versions or types of software applications (e.g., only a particular version 18.0.1 of the Firefox web browser). If an exam taker attempts to use a different version or type of application, the testing application 150 may prevent execution of that application or specific version thereof. The testing application 150 may further inform the exam taker that an upgrade or different type of browser is required. As such, an exam taker may be informed of certain system requirements in advance of an examination.

In some instances, the examination may involve a native application 175 in conjunction with or as a part of testing application 150. Native application 175 may encompass an application created by the testing administrator or otherwise developed specifically for administration of online examinations. Native application 175 may offer the general functionality of certain commercially available software applications, but without the functionality that offers possibility for engaging in illicit behavior during an examination. For example, a word processing application offers the ability for an exam taker to produce the text for a document according to instructions. That same application, however, also allows the exam taker the ability to access other notes created using the word processor.

In order to prevent illicit testing behavior, the word processor must allow for the generation of information through the usual input of data, but prohibit access to preexisting data. The word processor may also need to prevent an exam taker from copy-pasting data from study notes prior to the examination commencing. Notably, however, the exam taker may still need to copy-paste from originally generated answers during the course of the examination.

To implement these specific degrees of control, those specific limitations must first be identified and then conceived as to particular limitations (i.e., what is allowed and what is prohibited). A testing protocol must then be crafted that embodies these permission and prohibitions. To implement the protocol then requires interacting with various APIs, which is dependent upon an exam taker having a particular type of software application and version thereof installed. A natively derived word processing application may simply offer requisite functionality rather than cobble together a series of permitted functions in a commercially available word processing application.

In other instances, a commercial application such as Microsoft Word may be hosted at testing server 120 or some ancillary server in system 100 and allow for exam taker access to the same during the examination. By maintaining centralized hosting of a requisite application, exam takers are prohibited from exceeding the permitted use of that same application on their own computer 110. In such an instance, computing device 110 utilized by the exam taker (as well as that of testing server 120) may require hardware or software to allow for such multiplexed access and interaction. In some instances, this software may be an integrated part of testing application 150. In other instances, however, an exam taker may be required to install this software from a third-party, which may be certified by the entity offering the exam or examination.

A natively derived application 175 prepared for use in system environment 100 may be provided with respect to a web browser. This native browser may allow access to only those web sites directly related to the exam (e.g., providing examination questions) or that provide pre-approved exam materials such as manuals, regulations, or rules that might be referenced and cited by an applicant during an “open book” type examination. A native application 175 might also encompass a uniquely generated offering of questions in the context of a multiple choice type examination. Such an application may be akin to a survey that an exam taker might otherwise take on any number of websites on the Internet. In such an application, the exam taker is allowed to select a predetermined slate of options and only those options; access to any other applications on computing device 110 becomes irrelevant and unnecessary.

A native application 175 may also operate in conjunction with a commercial application during testing. For example, a testing protocol may indicate that all chat or electronic-mail applications are to be disabled by secure testing application 150, but that the exam taker may use a commercially available word processing application with limited functionality. The exam administrator may wish to offer technical assistance to the exam taker during the course of the examination in case some aspect of the exam becomes corrupted with respect to the delivery of data. A native application 175 dedicated to instant messaging or chatting with an approved technical support agent may be provided for use during the examination.

Secure testing application 150 may include an assessment module 170. Assessment module 170 may monitor activity on computing device 110 during administration of an examination. If an exam taker attempts to make changes to the system registry that were implemented by testing application 150, assessment module 170 may identify and report these attempts to proctoring center 130. Assessment module 170 may also check an output file for metadata or a keystroke log that might indicate an attempt to switch between accounts if a particular operating system allows for multiple exam takers (each of which would have their own unique system registry) or operating system environments in the case of computing device 110 operating with the use of a virtual machine. Assessment module 170 may further allow proctoring center 130 to monitor modifications or activity occurring at the computing device 110 in real-time, including changes at the registry level or, as described below in detail, activity occurring on-screen.

Secure testing application 150 and assessment module 170 may operate in conjunction with a detection device 180. Detection device 180 may receive real-time audio-visual data and may be a peripheral device, such as a camera or a microphone. The audio-visual data may be image data, audio data, or both. The audio-visual data may be biometric data, or it may be data related to an inanimate object. The camera may record still images, video, or both. Detection device 180 may reside within the computing device, as in the case of an internal webcam or microphone, or it may be an external device (e.g., a USB plug-and-play device). The real-time audio-visual data may be received from the exam taker or the exam-taking environment. For example, if the exam taker leaves his or her seat or another individual enters the testing area during the course of the examination, detection device 180 may receive real-time audio-visual data that suggests the absence of the exam taker or the presence of an individual other than the exam taker. Similarly, the real-time audio may indicate that the exam taker has turned his or her head or looked in a direction other than towards the examination.

In such cases, detection device 180 may provide the real-time audio-visual data to the assessment module 170. After receiving the real-time audio-visual data from detection device 180, assessment module 170 may in turn deliver the real-time audio-visual data to proctoring center 130 for analysis over communications network 140. The real-time audio-visual data may be delivered to proctoring center 130 as described in U.S. patent application Ser. No. 12/850,136 entitled “Optimized Data Stream Upload,” and U.S. patent application Ser. No. 12/913,694 entitled “Peered Proctoring,” the disclosures of which are incorporated herein by reference. System 100 may also utilize the cloud-related features described in U.S. patent application Ser. No. 12/899,085 entitled “Cloud Based Exam Environment,” the disclosure of which is incorporated herein by reference.

Alternatively, assessment module 170 may detect aberrant behavior in the real-time audio-visual data. The system may further include a library of known data that, if detected within the real-time audio-visual data, indicates aberrant behavior on the exam taker's part (i.e., aberrant data). The library may be an open-source library, or it may be a custom-populated library. Moreover, library may be stored locally on computing device 110, it may be received by the computing device as part of the examination, or it may be stored on a separate server. Persons of ordinary skill in the art will readily appreciate that various types of known libraries will work with the present invention. The known aberrant data may be image data, video data, or an object recognition function such as a Haar classifier.

Assessment module 170 may use any suitable framework for detecting known aberrant data within real-time audio-visual data (e.g., for detecting an image of a calculator within a streaming video). As shown in FIGS. 2 and 3, for example, assessment module 170 may incorporate a Speeded-Up Robust Features (SURF)-based algorithm. For example, where the known aberrant data comprises image or video data, assessment module 170 may detect aberrant data by using a SURF algorithm or any other suitable comparison or detection algorithm to compare the real-time audio-visual data to the known image or video data. If the exam administrator or proctor has determined that using a calculator during an exam is aberrant behavior, library X may include stored known image data corresponding to a calculator, such as one or more images of a calculator. In such a scenario, detection device 180 may be a video camera and may receive video data from the exam-taking environment throughout the exam period. Assessment module 170 may then continuously compare the real-time video data received by detection device 180 to the known calculator images stored in library X. Assessment module 170 may utilize existing open source software, as discussed below in further detail, or it may use proprietary software.

FIG. 2 shows an exemplary interface of assessment module 170 in which the real-time audio-visual data 210 is an image containing a road 220, a stop sign 230, and various landscape-related features 240. The known image 250 is a generic image of a stop sign 260. In FIG. 2, assessment module 170 has not yet executed the SURF-based detection algorithm. FIG. 3 shows the same exemplary interface 300 after assessment module 170 has executed the SURF-based detection algorithm. In FIG. 3, assessment module 170 has successfully detected the presence of the stop sign 310 from amongst the road 320 and other landscape features 330 within the real-time audio-visual data 340.

As noted above, assessment module 170 may use any suitable framework for detecting known aberrant data within real-time audio-visual data. For example, assessment module 170 may utilize the Open Source Computer Vision (OpenCV) library maintained by OpenCV.org or other suitable library. OpenCV is an open-source library of programming functions related to real-time computer vision.

Using the OpenCV library, assessment module 170 may utilize Haar training to build Haar classifiers that correspond to various categories of known aberrant data. Haar classifiers may be created by training assessment module 170 to recognize numerous positive and negative samples of a particular type of known aberrant data. For example, a Haar classifier for detecting a calculator may be created by subjecting the assessment module 170 to numerous positive and negative images of calculators.

Alternatively, where detection device 180 is a microphone, detection device 180 may monitor the exam-taking environment for sounds that constitute aberrant data. For example, sound-related aberrant data may include the sound of a human speaking, music playing, or any sound other than those normally associated with exam-taking (e.g., the flipping of pages in an exam booklet, sneezing, coughing, sighing, etc.).

When assessment module 170 positively identifies aberrant data, it may react to the aberrant data by notifying an on-site proctor, by notifying proctoring center 130, or by automatically disabling part or all of the examination altogether. Where system 100 includes proctoring center 130, assessment module 170 may automatically react to a positive identification of aberrant data by alerting proctoring center 130. Where system 100 includes an on-site proctor, assessment module 170 may automatically react to a positive identification of aberrant data by alerting the on-site proctor. Assessment module 170 may alert the on-site proctor in any suitable manner known in the art, such as by producing an alarming sound, or by sending an electronic message (e.g., a text message). Proctoring center 130, which may likewise monitor the real-time audio-visual data received by detection device 180, may then focus in on the cause of the positive identification and intervene if necessary. The real-time audio-visual data may be transmitted from computing device 110 to proctoring center 130 over communications network 140. The testing protocols delivered by testing server 120 may instruct testing application 150 to allow the network card to remain enabled while simultaneously limiting network connectivity to certain ports. For example, with respect to e-mail, an SMTP service operates on port 25 while a POP3 service operates on port 110. Testing application 150 could prohibit access to ports 25 and 110 while not blocking any ports necessary for proctoring center 130 to receive the real-time audio-visual data.

Proctoring center 130 may then determine if any of the real-time audio-visual data suggests aberrant activity in violation of the testing protocol. Proctoring center 130 may log the information for further assessment by the actual exam administrator (e.g., the professor or professional association administering the examination) or may directly address the exam taker about the aberrant behavior and issue any necessary warnings or further instructions.

Assessment module 170 may also be used in conjunction with known validated data, the absence of which constitutes an aberrant occurrence. For example, the known validated data may include information collected during registration, such as the exam taker's name, testing identification number, or password. Other known validated data may include biometric information such as the exam taker's image. In such a case, detection device 180 may continuously receive real-time audio-visual data from the exam-taking environment that relates to the exam taker's face. Assessment module 170 may then continuously compare the real-time audio-visual data to the known validated image of the exam taker. When assessment module 170 detects the image of a person that is not the registered exam taker, it react as described above. Known validated data may be stored in a library in the same manner as described above with regard to known aberrant data. Assessment module 170 may similarly compare and authenticate or fail to authenticate an exam taker's voice print, retinal scan, or finger prints. In such case, additional peripheral detection devices may be used (e.g., a fingerprint or retinal scanner).

A further registration technique may include the exam taker typing in a previously typed in phrase. The nuances of the exam taker having entered the sentence previously and during the actual testing event as they pertain to the natural speed, and pauses, and so forth may be observed and compared. As a result, the likelihood that the exam taker is the purported exam taker may be determined. All of the aforementioned information may be maintained in storage at a testing registration server 160. Testing registration server 160 may be maintained by proctoring center 130, in a secure database of information at a site designated by the actual exam administrator, or that of a third-party commercial vendor.

Assessment module 170 may also operate in conjunction with a testing protocol to properly execute a testing routine for the given testing event. For example, the testing routine may allow for the exam taker to have access to all questions at any given time such that the exam taker may answer and not answer questions at their leisure and subsequently return to any questions at a later time for further review. The testing routine may alternatively require the exam taker to lock in an answer or set of answers and have the same reported to testing server 120 prior to receiving a subsequent question.

The routine may alternatively require that a question be locked in, but assessment module 170 may not deliver the answer to testing server 120 until some or all of the exam has concluded, or as part of a regular batch transmission. Answer delivery may also occur in real-time. As such, assessment module 170 and testing server 120 may operate in a binary fashion with certain data being reported to proctoring center 130 in conjunction with each answer. Other testing routine parameters might include time, number of questions answered, or number of questions answered correctly or incorrectly. Data exchanged between testing server 120 and assessment module 170 of secure testing application 150 may be encrypted.

In an embodiment, a method for detecting aberrant behavior in a testing environment may include receiving real-time audio-visual data from a detection device and executing an application stored in memory. Execution of the application by a processor may cause the processor to detect aberrant data within the real-time audio-visual data and reacts automatically to the aberrant data. Reacting automatically to the aberrant data may include reacting to a positive identification of aberrant data by sending an alert to a remote proctoring center. Reacting automatically to the aberrant data may further include reacting to a positive identification of aberrant data by alerting an on-site proctor. Reacting automatically to the aberrant data may also reacting to a positive identification of aberrant data by disabling the examination.

In another embodiment, a non-transitory computer-readable storage medium may have an executable program embodied thereon. Execution of the program by a processor may perform a method for detecting aberrant behavior in a testing environment, which may include receiving real-time audio-visual data from a detection device, detecting aberrant data within the real-time audio-visual data, and reacting automatically to the aberrant data.

FIG. 4 illustrates a method 400 for implementing an online proctored examination. In step 410, a testing account is created by an exam taker. The exam taker may utilize an interface like that illustrated in FIG. 5. In step 420, an exam taker registers for and/or schedules an examination. The exam taker may utilize an interface like that illustrated in FIG. 5 for registration and FIG. 6 for scheduling. In step 430, an exam taker engages in biometric enrollment and authentication as is described in greater detail in the context of FIGS. 7, 8, and 9. In step 440, the exam is delivered and proctoring commences at step 450.

Proctoring step 450 may take place over the course of the examination and invoke any variety of security technologies and processes may be utilized to deter and detect aberrance during the testing process. By locking down the computing device, the exam taker cannot use other applications, keyboard functions such as print or copy, or exit the testing application until allowed by the parameters of a particular examination. If an individual circumvents, attempts to circumvent, or even innocently uses a locked out functionality, that activity may be reported to either proctoring center 130 or an on-site proctor.

As noted above, the examination may also be monitored in real-time by proctoring center 130 through detection device 180. Assessment module 170 may automatically alert or react to positively identified aberrant behavior in the manner described above. Assessment module 170 may also monitor detection device 180 for losses in video or audio quality. Such losses may then be automatically reported to proctoring center 130. Assessment module 170 may also monitor the examination for unusual testing behavior based on historical testing statistics or real-time forensic data. Historical testing statistics may include an exam taker's past performance on examinations. For example, if an exam taker's historical performance statistics indicated that the exam taker was a “C student,” assessment module 170 may view an exam taker's overly strong performance (e.g., having correctly answered 100% of the questions) as indicative of potentially aberrant behavior. Real-time forensic data may include an exam taker's response times. For example, if an exam taker took a mere half second between answers and answered one hundred questions correctly, assessment module 170 may view such real-time forensic data as indicative of aberrant behavior. In response to such positive identifications of aberrant behavior, assessment module 170 may react in the manner described above.

Other security measures may include delivering one question at a time during step 440. Rather than allowing an exam taker to access all of the questions from the outset of the examination, the questions may be provided as needed to prevent an exam taker from capturing or recording the information and passing it along to others. Questions may likewise be delivered with a delay or in a staggered fashion during step 440. Doing so may increase the likelihood that aberrant behavior will be detected. Breaks taken by an exam taker may also require re-authentication or permanent lock down and delivery of already provided answers. In such cases, an exam taker may not be allowed to revisit those questions. The exam taker may be reminded as to the finality of any responses prior to taking such a break.

FIG. 5 illustrates a branded interface 500 for establishing an exam taker account. The interface 500 may be designed for a particular assessment entity such as a university or professional association and reflect a brand 510 of the same. The interface 500 may be particular to a specific class or examination or a series of classes or examinations. Through interface 500, an exam taker may provide contact information such as a name 520, address 530, and e-mail address 540 in addition to a login name 550 and password or secret word 560. Such entries may be randomly generated by the assessment entity and assigned to the exam taker. Other information fields that are specific to or required by the exam-taking entity 570 may also be provided. Information provided by the exam taker may be maintained at registration server 160 as described in FIG. 1. The entity offering the assessment services may determine how much information is needed to complete the registration process.

FIG. 6 illustrates an interface 600 for scheduling an online proctored examination. Interface 600 may share similar branding 605 as the registration interface 500 of FIG. 5 where an exam taker provided name, address, and other registration information. Scheduling interface 600 may be launched following the completion of registration activity via interface 500 in FIG. 5 or following a secure login process.

Scheduling interface 600 of FIG. 6 may provide a calendar 610 that may identify dates that the examination is provided or to allow the exam taker to select a date of his or her choice for on-demand testing. Scheduling interface 600 may also provide a start time menu 620 that may identify available starts times or to allow an exam taker to provide a time of their choice for starting on-demand testing. A disclaimer window 630 may also be provided to communicate any specific information related to the examination including restrictions on use, eligibility, and disclosure. An acknowledgment box 640 may also be provided to allow the exam taker to acknowledge that they have reviewed any disclaimer information provided in window 630.

FIG. 7 illustrates a method 700 related to capturing biometric information utilized in an online proctored examination. Based on the specific requirements of each exam, an exam taker may be prompted to capture or allow for the capture of biometric enrollment information. When the exam is delivered, a biometric authentication process may authorizing the examination to commence after validating the identity of the exam taker and authenticating certain data.

In step 710, a biometric enrollment image of the exam taker may be taken. The image may be taken when the exam taker initially enrolls in the web-based testing solution. The image may be subsequently used as validated data against which assessment module 170 may compare real-time audio-visual data. The system may receive the validated image data through detection device 180 as illustrated in FIG. 1, or it may be received from an external source, such as from a database containing photos taken by an exam taker when registering for his or her first day of class at a university.

In step 720, a biometric enrollment keystroke analysis may occur. The keystroke analysis may create a biometric profile based on the typing patterns of an exam taker. During a subsequent authentication operation, a fraud detection component of the analytics software may identify typing patterns that do not match the biometric enrollment profile. Assessment module 170 may then alert proctoring center 130.

In step 730, a biometric authentication process takes place. The authentication process of step 730 may compare the previously acquired photograph from step 710 with a current photograph of the exam taker and/or compare biometric information related to typing patterns with the previously input typing sample from step 720.

In step 740, if the biometric information from both the photograph and keystroke analysis is within an acceptable range of acceptability, then the examination is launched. If the photograph of the exam taker fails to correspond to that of the exam taker at enrollment and/or the typing analytics software identifies an anomaly, then the exam is suspended at step 750 and the proper entities are altered with respect to addressing the anomalies. Alternatively, the examination may be allowed to proceed, but under a flag of caution requiring further analysis during grading.

FIG. 8 illustrates an interface 800 for capturing biometric information related to keystroke analytics. Interface 800 may display a phrase 810 that the exam taker must type. Typing patterns of particular series of letters, numerals, and phrases are similar to fingerprints or other biometric information in that they are unique to a particular person. For example, a first exam taker will exhibit specific nuances related to the entry of that series of letters, numerals, and phrases versus those of a second exam taker. These nuances may include the speed at which the series of letters, numbers, and phrases are entered; pauses between certain letters, numbers, and phrases, and if a keyboard offers pressure sensitive detection, the intensity with which the exam taker enters that information (e.g., how hard the exam taker types).

An exam taker may be asked to provide a typing sample during a registration activity, which may occur upon initial registration with the assessment provider. Upon the actual taking of the examination (or immediately beforehand) the exam taker may be asked to enter the aforementioned phase 810 to verify that the same person is entering the phrase and that the exam taker is who they purport to be. The initial sampling may involve a series of random phrases that may be selected at random or that may be analyzed to identify specific typing patterns and then used to generate and analyze a subsequently entered phrase. An exam taker may be allowed a finite number of opportunities to enter the phrase prior to a proctor being alerted. This information may be maintained at a registration server 160 or some other computing device tasked with maintaining this information.

FIG. 9 illustrates an interface 900 for capturing biometric information related to visual recognition of an exam taker. Interface 900 may provide an exam taker with instructions 910 concerning positioning detection device 180 to take capture real-time audio-visual data (e.g., a photograph) of an exam taker. This process may be undertaken at the registration phase, before the taking of the examination, or both.

Photographs and typing samples may be examined during the course of the examination. For example, a pop-up window may requests intermittent verifications of typing samples and visual identity. The video may also be analyzed in real-time and seamlessly without the involvement of the exam taker. The actual entry of exam answers may be analyzed for the purpose of ensuring keystroke analytics. FIG. 9 also illustrates exemplary instructions 920 concerning placement of an detection device 180.

The previously stored photograph 930, as discussed in the context of FIG. 7, may then compared to the real-time photograph 940 to ensure that the exam taker is who they purported to be. The photograph may be examined by an actual human being at proctoring center 130 or through the exam taker of facial recognition software that analyzes particular points on the face and body of the exam taker to ensure an acceptable degree of commonality that ensures the identity of the exam taker. If the registration photograph and the real-time photograph are not consistent, a proctor may be alerted to take further action and to delay administration of the examination as discussed with respect to FIG. 7 at steps 730 and 750.

Other means of ensuring identity or security of a testing locale may be used, including voice sampling and listening in to ensure that no third-parties are speaking to the exam taker. Comparison of voice samples may occur in a fashion similar to that of comparison of photographs. Further, a voice sample of the exam taker may be compared against any other voices detected during the examination process whereby a voice that does not correspond to the exam taker triggers proctor intervention.

Other means of verifying the identify of an exam taker might be invoked including the use of a fingerprint or other biometric information through a detection device coupled to the testing device and which may be more common at a dedicated testing center. Providing random information such as a student ID, a driver's license, or swiping a credit card or other identification card through a coupled scanning device could also be used.

FIG. 10 illustrates interface 1000 utilized in proctoring an online examination and as might be observed at proctoring center 130. Interface 1000 may allow for simultaneous observation multiple sessions. FIG. 10 depicts a single active session 1010 being observed from a total of twelve possible sessions 1020. Session 1010 displays the real-time audio-visual data received by detection device 180 and transmitted to proctoring center 130, either directly or intermediately through assessment module 170. Because session 1010 depicts aberrant behavior, interface 1000 displays alert 1030. As noted above, assessment module 170 may work in conjunction with detection device 180 to automatically detect aberrant data within the real-time audio-visual data displayed in active session 1010. FIG. 10 also illustrates a session ID 1040 that is unique to the exam taker, a proctor identification field 850 that identifies the proctor responsible for observing the testing session, and start/end time fields 1060 for the testing session. All of this information may be utilized in generating assessment data or logs following completion of the examination.

Where either or both proctoring center 130 and assessment module 170 positively identify aberrant behavior and/or aberrant data, respectively, interface 1000 may automatically expand session 1010 into a larger view as shown in FIG. 11. The expanded session may then be further investigation through interface 1100. The real-time audio-visual data may be automatically recorded for purposes of capturing evidence that the exam administrator may need to validate any subsequent disciplinary actions against the exam taker. In some instances the aberrant data may simply indicate that the testing environment needs to be modified in order to ensure proper proctoring, which may include raising the light level, decreasing background noise (e.g., closing a window), or otherwise manually influencing the physical testing environment. A proctor may provide such information to an exam taker.

Interface 1100 also illustrates a current alert log 1120 that identifies the specific aberrant behavior or data that lead to automated alert 1030 in interface 1000 of FIG. 10. Proctoring center 130 may log the outcome of their determination related to the aberrant behavior in response log 1130. Response log 1130 allows a proctor to identify the particular behavior 1132 that was at issue (e.g., an audio problem or multiple people being present) and any responsive action 1134 taken to correct the positively identified aberrant behavior or data. Such actions may include clearing the alert as a false alert, terminating the examination, or marking the determination as inconclusive and allowing the exam to continue. A proctor may also launch an on-demand verification of audio, visual, or keystroke analytics. Notes related to the incident may also be maintained in notes section 1136 to further detail the specific incident. In some instances, the proctor may launch a live chat session with the exam taker while maintaining real-time observation through detection device 180. Proctoring center 130 may also log any positive identifications of aberrant behavior or data. For example, proctoring center 130 may wish to simply log the unusual behavior and allow the actual exam administrator to determine any subsequent actions. Proctoring center 130 may associate logs with recorded real-time audio-visual data.

The interface 1100 may also maintain additional information such as a historical alert log 1140 that maintains a running list of all aberrant behavior for the exam taker in question as well as security information 1150, session information 1160, and testing program information 1170. Security information 1150 may display specific information about an exam taker, including biometric information such as a photograph. Session information 1160 may display information such as the name of the exam taker, the number of testing items answered, the number of breaks taken, and so forth as illustrated in FIG. 11. Information concerning specific protocols related to the examination may be identified in testing program information window 1170.

In the present disclosure, computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASHEPROM, any other memory chip or cartridge.

Various forms of transmission media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU. Various forms of storage may likewise be implemented as well as the necessary network interfaces and network topologies to implement the same.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise.

What is claimed is:

1. A system for detecting aberrant behavior in a testing environment, comprising:
a detection device that receives real-time audio-visual data; and
a computing device communicably coupled to the detection device, the computing device having a testing application stored in memory, the testing application including an executable assessment module, whereby execution of the assessment module by a processor:
detects aberrant data within the real-time audio-visual data; and
reacts automatically to the aberrant data.

2. The system of claim 1, further comprising a server communicably coupled to the computing device by a network, the server having executable instructions stored in memory, whereby execution of the instructions by a processor sends an examination to the computing device.

3. The system of claim 2, further comprising a registration server communicably coupled to the computing device by a network, the registration server having executable instructions stored in memory, whereby execution of the instructions by a processor authenticates an exam taker to access the examination.

4. The system of claim 1, wherein the detection device is a peripheral device.

5. The system of claim 4, wherein the peripheral device is a video camera.

6. The system of claim 5, wherein the video camera is a webcam.

7. The system of claim 4, wherein the peripheral device is a microphone.

8. The system of claim 1, wherein the real-time audio-visual data is image data.

9. The system of claim 1, wherein the real-time audio-visual data is audio data.

10. The system of claim 1, wherein the real-time audio-visual data is biometric data.

11. The system of claim 1, further comprising a library stored in memory of a library server communicably coupled to the computing device by a network, the library storing known aberrant data.

12. The system of claim 11, wherein the detecting aberrant data within the real-time audio-visual data includes comparing the received real-time audio-visual data to the known aberrant data stored in the library.

13. The system of claim 1, wherein reacting automatically to the aberrant data includes reacting to a positive identification of aberrant data by sending an alert to a remote proctoring center.

14. The system of claim 1, wherein reacting automatically to the aberrant data includes reacting to a positive identification of aberrant data by alerting an on-site proctor.

15. The system of claim 1, wherein reacting automatically to the aberrant data includes reacting to a positive identification of aberrant data by disabling the examination.

16. A method for detecting aberrant behavior in a testing environment, comprising:
receiving real-time audio-visual data from a detection device; and
executing an application stored in memory, whereby execution of the application by a processor:
detects aberrant data within the real-time audio-visual data; and
reacts automatically to the aberrant data.

17. The method of claim 16, wherein reacting automatically to the aberrant data includes reacting to a positive identification of aberrant data by sending an alert to a remote proctoring center.

18. The method of claim 16, wherein reacting automatically to the aberrant data includes reacting to a positive identification of aberrant data by alerting an on-site proctor.

19. The method of claim 16, wherein reacting automatically to the aberrant data includes reacting to a positive identification of aberrant data by disabling the examination.

20. A non-transitory computer-readable storage medium having an executable program embodied thereon, wherein execution of the program by a processor performs a method for detecting aberrant behavior in a testing environment, the method comprising:
receiving real-time audio-visual data from a detection device;
detecting aberrant data within the real-time audio-visual data; and
reacting automatically to the aberrant data.
